(19) United States
(12) Patent Application Publication
(10) Pub. No.: US 2025/0190882 A1
(43) Pub. Date: Jun. 12, 2025

(54) SELECTIVE DATA STORAGE BASED ON FUTURE EVENT PREDICTION

(71) Applicant: Capital One Services, LLC, McLean, VA (US)

(72) Inventors: Samuel SHARPE, Cambridge, MA (US); Galen RAFFERTY, Mahomet, IL (US); Brian BARR, Schenectady, NY (US); Michael DAVIS, Arlington, VA (US); Taylor TURNER, Richmond, VA (US); Kenny BEAN, Herndon, VA (US)

(73) Assignee: Capital One Services, LLC, McLean, VA (US)

(21) Appl. No.: 18/533,762

(22) Filed: Dec. 8, 2023

(51) Int. Cl. G06N 20/20

(52) U.S. Cl. CPC G06N 20/20

(57) ABSTRACT

A method and related system for storing data based on predictions includes obtaining, from a client device, a first set of update data and a time-related prediction generated by a client-side version of a machine learning model. The method further includes determining that the time-related prediction is associated with a first data store of a plurality of data stores comprising the first data store and a second data store. The method further includes updating a record in the first data store based on the first set of update data in response to a determination that the time-related prediction is associated with the first data store. The method further includes updating the record in the first data store based on a second set of update data obtained after obtaining the first set of update data.

### SUMMARY

The availability of various types of memory storage provides significant advantages in the field of computing, especially with regards to cloud computing. However, optimizing the use of various types of memory storage can be difficult due to a lack of understanding about how often data may be retrieved or updated. Moreover, in many cases, certain types of information that would be useful for determining a data store in which to store data may be inaccessible to a server and instead may be restricted to a local client device.

Some embodiments of the disclosed technology may overcome the technical issue described above by selecting a data store for use based on a machine learning model prediction that indicates a predicted future time at which a future event occurs or a future duration in which the future event occurs. Some embodiments may perform operations to provide, to a client device, a machine learning model that outputs time-related predictions indicating a most probable time for a future event based on update data. The machine learning model may then be used by the client device to make a time-related prediction for when a future event will occur. Some embodiments may then obtain, from the client device, initial update data and a time-related prediction that is generated by the client device. Some embodiments may then determine whether the time-related prediction satisfies a set of criteria associated with a first data store, where the first data store is selectable from among a plurality of data stores.

Some embodiments may then determine that the time-related prediction is associated with the first data store based on a determination that the time-related prediction satisfies the set of criteria. Some embodiments may then update a record in the first data store based on the initial update data in response to a determination that the time-related prediction is associated with the first data store. Some embodiments may then receive, from the client device, additional update data after obtaining the initial update data, where the additional update data shares an identifier with the initial update data. Some embodiments may then retrieve the record based on an association between the additional update data and the initial update data and update the record in the first data store based on the additional update data. By using a time-related prediction, some embodiments may more accurately determine which data store is most appropriate for storing data of a particular type. Furthermore, by using a client device, some embodiments may reduce server-side computational requirements for performing predictions and also use learning models that can rely on client-accessible data that may be inaccessible to a server.

Various other aspects, features, and advantages will be apparent through the detailed description of this disclosure and the drawings attached hereto. It is also to be understood that both the foregoing general description and the following detailed description are examples and not restrictive of the scope of the invention.

### BRIEF DESCRIPTION OF THE DRAWINGS

Detailed descriptions of implementations of the present technology will be described and explained through the use of the accompanying drawings.

FIG. 1 illustrates an example of a system for intelligently storing data, in accordance with some embodiments.

FIG. 2 illustrates a conceptual diagram of a system for determining what data to store based on multi-scale time-related predictions, in accordance with some embodiments.

FIG. 3 is a flowchart of a process for determining what data to store based on client-provided, time-related predictions, in accordance with one or more embodiments.

The technologies described herein will become more apparent to those skilled in the art by studying the detailed description in conjunction with the drawings. Embodiments of implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

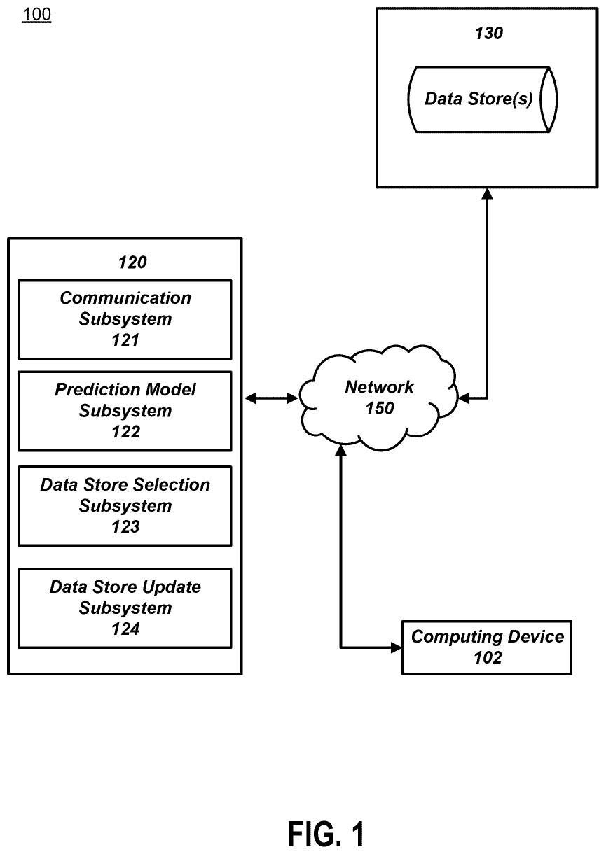

FIG. 1 illustrates an example of a system for intelligently storing data, in accordance with some embodiments. The system 100 includes a computing device 102. The computing device 102 may include computing devices such as a desktop computer, a laptop computer, a wearable headset, a smartwatch, another type of mobile computing device, a transaction device, etc. In some embodiments, the computing device 102 may communicate with various other computing devices via a network 150, where the network 150 may include the internet, a local area network, a peer-to-peer network, etc. The computing device 102 may send and receive messages through the network 150 to communicate with a set of servers 120, where the set of servers 120 may include a set of non-transitory storage media storing program instructions to perform one or more operations of subsystems 121-124.

While one or more operations are described herein as being performed by particular components of the system 100, those operations may be performed by other components of the system 100 in some embodiments. For example, one or more operations described in this disclosure as being performed by the set of servers 120 may instead be performed by the computing device 102. Furthermore, some embodiments may communicate with an application programming interface (API) of a third-party service via the network 150 to perform various operations disclosed herein. For example, some embodiments may store and update machine learning models using an API accessible via the network 150.

In some embodiments, the set of computer systems and subsystems illustrated in FIG. 1 may include one or more computing devices having electronic storage or otherwise capable of accessing electronic storage, where the electronic storage may include the set of data stores 130. The set of data stores 130 may include values used to perform operations described in this disclosure. For example, the set of data stores 130 may store machine learning model parameters (e.g., neural network weights, biases, etc.), user information, update information, transaction information, or other types of information. As described elsewhere in this disclosure, in some embodiments, the set of data stores 130 may be stored in various types of memory systems that vary in capabilities in throughput and latency. For example, to implement one or more data stores of the set of data stores 130, some embodiments may use an in-memory database or caching service, high-performance solid-state storage devices, object storage data systems, cold storage systems, or mechanical hard disk drives.

In some embodiments, a communication subsystem 121 may send data to or receive data from various types of information sources or data-sending devices, including the client computing device 102. For example, the communication subsystem 121 may obtain, from the client computing device 102, update data that causes an update to a record stored in a data store or a learning model-generated prediction. As described elsewhere in this disclosure, some embodiments may select a data store to receive the update data or other data derived from the update data. For example, the communication subsystem 121 may send update data to one or more data stores of the set of data stores 130 or send machine learning model parameters to the computing device 102.

In some embodiments, a prediction model subsystem 122 may perform operations to predict time-related value used to indicate a most probable time for a future event. The time-related value may include a time value directly, a probability value associated with a specific time or time interval, or another type of value that may be used by itself or in combination with other obtained values to predict a likelihood for a probable time for a future event. The future event may include a future use of an application, a future initiation of a specific action that can be caused by the application, a specific type of interaction with an application, an initiation of a database transaction, etc.

Furthermore, the prediction model subsystem 122 may include operations to send model parameters of the prediction model subsystem 122 to client devices, such as the computing device 102. For example, the prediction model subsystem 122 may retrieve a set of model parameters from the set of data stores 130 and send the retrieved set of model parameters to the computing device 102. As described elsewhere in this disclosure, the computing device 102 may execute a version of a machine learning model configured by the set of model parameters to generate a client-side prediction. The computing device 102 may then send the client-side prediction to the set of servers 120 via the communication subsystem 121. By sending model parameters of the prediction model subsystem 122 to the computing device 102, some embodiments may reduce the computational resource use of the set of servers 120 and take advantage of a federated architecture that can use both server and client computing resources. Furthermore, some embodiments may implement machine learning models that rely on private data that can only be locally accessed by a client device and would not normally be available to a server-side application.

In some embodiments, a data store selection subsystem 123 may perform operations to help with the selection of a data store of the set of data stores 130. For example, some embodiments may select one or more data stores with which to update data based on a prediction value, such as a time-related prediction. As described elsewhere, some embodiments may obtain a time-related prediction from the computing device 102 or may use the prediction model subsystem 122 to directly determine the time-related prediction. Some embodiments may then use the time-related prediction to select a duration associated with the time-related prediction. For example, if the time-related prediction is a predicted future time, some embodiments may select a time interval in which the predicted future time value resides. Some embodiments may then select a data store associated with that time interval. Alternatively, the time-related prediction may be a probability value or parameter of a probability distribution function indicating one or more likelihoods that a future event will have occurred for a set of durations. Some embodiments may select a data store associated with a duration that is itself associated with a likelihood based on a determination that the likelihood satisfies a likelihood threshold or another time-related set of criteria.

In some embodiments, the data store selection subsystem 123 may apply additional criteria before confirming the selection of a data store. For example, some embodiments may determine whether a candidate selected data store has sufficient memory to store any updated data before actually permitting the use of the candidate selected data store. Alternatively, or additionally, some embodiments may determine whether other performance parameters (e.g., a required data throughput or a required latency) are satisfied.

In some embodiments, a data store update subsystem 124 may update a record in a selected data store. The data store update subsystem 124 may generate, modify, or otherwise update a record in the selected data store based on update data obtained via the communication subsystem 121. For example, after the communication subsystem 121 obtains transaction data and a time-related prediction associated with the transaction data, some embodiments may select a first data store using the data store selection subsystem 123. Some embodiments may then use the data store update subsystem 124 to update a record in the selected first data store based on the transaction data, where the transaction data may include a first identifier that is used to index the record or is otherwise associated with the record.

Furthermore, some embodiments may receive additional update data that is associated with previously provided update data. For example, some embodiments may receive additional transaction data indicating a previous transaction identifier. In some embodiments, the data store update subsystem 124 may detect the presence of this previous transaction identifier based on the additional transaction data and, in response, retrieve the record that was previously updated based on the previously provided update data, where the record is stored in a selected first data store. In some embodiments, detecting the shared identifier may cause one or more operations to be skipped, such as a prediction operation using the prediction model subsystem 122 or a data store selection operation that is performed by the data store selection subsystem 123.

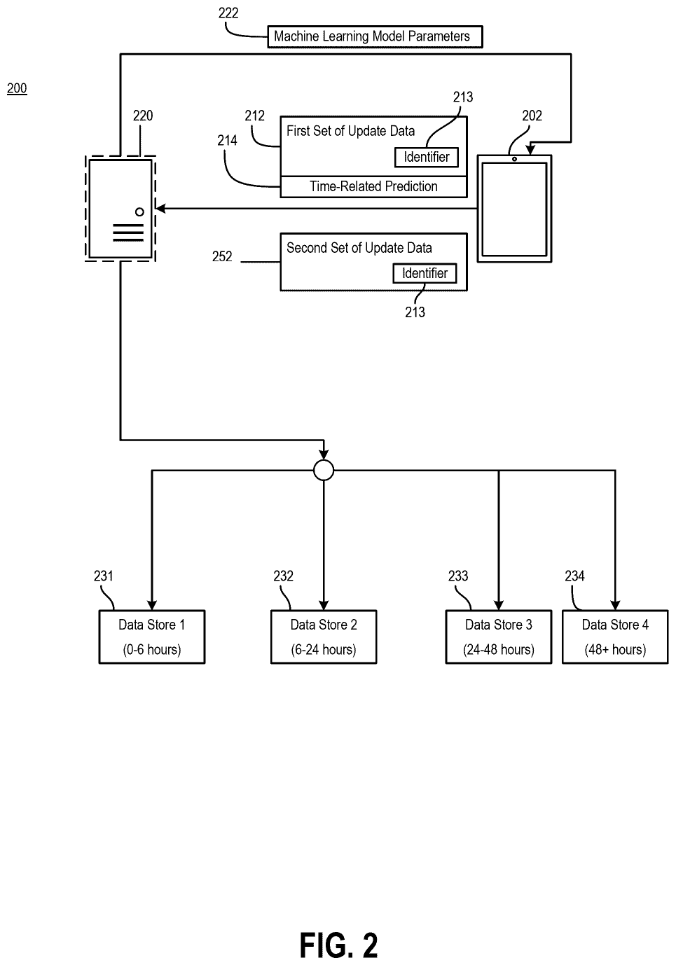

FIG. 2 illustrates a conceptual diagram of a system for determining what data to store based on multi-scale time-related predictions, in accordance with some embodiments. In some embodiments, a set of servers 220 may send a set of machine learning model parameters 222 to a client computing device 202. The client computing device 202 may then configure a machine learning model based on the set of machine learning model parameters 222. As described elsewhere in this disclosure, a machine learning model configured with the set of machine learning model parameters 222 may include one of various types of machine learning models, such as a neural network model, a decision tree model (e.g., a random forest model), a support vector machine model, a naïve base model, etc.

The client computing device 202 may later participate in an online transaction or other interaction which may cause an update to a record of an online account. The client computing device 202 may then generate a set of time-related predictions 214 using the configured machine learning model implemented on the client computing device 202 and send the set of time-related predictions 214 to the set of servers 220. The client computing device 202 may provide a first set of update data 212 to the set of servers 220, where the first set of update data 212 may indicate information regarding this online transaction or other interaction. The first set of update data 212 may include an identifier 213, where the identifier 213 may include a user identifier, a transaction identifier, some other type of numeric or character sequence, etc.

While the system 200 depicts the client computing device 202 providing prediction results, some embodiments may perform prediction operations without relying on predictions generated by a client computing device. For example, some embodiments may implement a server-side version of a machine learning model that receives update data as inputs and outputs a time-related prediction that is then used to select a data store, as described elsewhere in this disclosure.

After obtaining the set of time-related predictions 214, an application executing on the set of servers 220 may apply a set of criteria to the set of time-related predictions 214 to determine which data store of the data stores 231-234 to select for storing a first record based on the first set of update data 212. In some embodiments, the first data store 231 may be associated with a first duration of 0 to 6 hours, the second data store 232 may be associated with a second duration of greater than 6 to 24 hours, the third data store 233 may be associated with a third duration of greater than 24 hours to 48 hours, and a fourth data store 234 may be associated with a fourth duration of any time greater than 48 hours.

In some embodiments, the set of time-related predictions 214 may provide a time value directly. For example, an application executing on the set of servers 220 may obtain the set of time-related predictions 214 to determine that a future transaction is most likely to occur at 5 hours from a current transaction indicated by the first set of update data 212. In response, some embodiments may select the first data store 231 for record generation based on the first set of update data 212. Alternatively, the set of time-related predictions 214 may cause the application executing on the set of servers 220 to determine that a future transaction is most likely to occur at 10 hours from a current transaction indicated by the first set of update data 212. In response, some embodiments may select the second data store 232 for record generation based on the first set of update data 212. Alternatively, the set of time-related predictions 214 may cause the application executing on the set of servers 220 to determine that a future transaction is most likely to occur at 30 hours from a current transaction indicated by the first set of update data 212. In response, some embodiments may select the third data store 233 for record generation based on the first set of update data 212.

In some embodiments, the set of time-related predictions 214 may indicate one or more probabilities that a next target event will occur within a pre-established duration. The set of time-related predictions 214 may indicate that there is a 95% chance that a future transaction is most likely to occur within a pre-established time of 6 hours from the current transaction indicated by the first set of update data 212. In response, some embodiments may select the first data store 231 for record generation based on a determination that this 95% chance exceeds a likelihood threshold of 75%.

Alternatively, if the set of time-related predictions 214 indicate one or more probabilities that a next target event will occur within a pre-established duration, the set of time-related predictions 214 may indicate that: (i) there is a 55% chance that the future transaction is most likely to occur within a pre-established time of 6 hours from the current transaction; (ii) there is an 85% chance that a future transaction is most likely to occur within the pre-established time of 24 hours from the current transaction; and (iii) there is a 95% chance that a future transaction is most likely to occur within the pre-established time of 48 hours from the current transaction. In response, some embodiments may select the second data store 232 for record generation based on a determination that this 85% associated with the second data store 232 exceeds the likelihood threshold and that the time interval of the second data store 232 has the least maximum duration of the data stores associated with likelihoods exceeding the minimum likelihood threshold.

Alternatively, if the set of time-related predictions 214 indicate one or more probabilities that a next target event will occur within a pre-established duration, the set of time-related predictions 214 may indicate that: (i) there is a 25% chance that the future transaction is most likely to occur within a pre-established time of 6 hours from the current transaction; (ii) there is a 52% chance that a future transaction is most likely to occur within the pre-established time of 24 hours from the current transaction; and (iii) there is an 88% chance that a future transaction is most likely to occur within the pre-established time of 48 hours from the current transaction. In response, some embodiments may select the third data store 233 for record generation based on a determination that the 88% associated with the third data store 233 exceeds the likelihood threshold and that the time interval of the third data store 233 has the least maximum duration with respect to likelihoods exceeding the minimum likelihood threshold.

It should be understood that other embodiments may be provided with other types of time-related predictions or generate other types of time-related predictions. For example, some embodiments may be provided with a category value that indicates a duration of time within which a target event is likely to occur, where the standards for likeliness may be pre-configured (e.g., an event that has at least a 51% chance of occurring is likely to occur). Some embodiments may then select a data store from a plurality of data stores based on the category value.

In some embodiments, the client computing device 202 may send a second set of update data 252 that also includes the identifier 213. Some embodiments may then forgo generating or processing a time-related prediction for a future event and, based on the shared identifier 213, select a data store that was previously selected based on the first set of update data 212. For example, after selecting the second data store 232 based on the set of time-related predictions 214, some embodiments may then receive the second set of update data 252. Some embodiments may then cross-reference the identifier 213 and select the second set of update data 252. By using the identifier 213, some embodiments may forgo an additional data store selection operation that requires the use of any time-related predictions provided in conjunction with the second set of update data 252 or computed from the second set of update data 252.

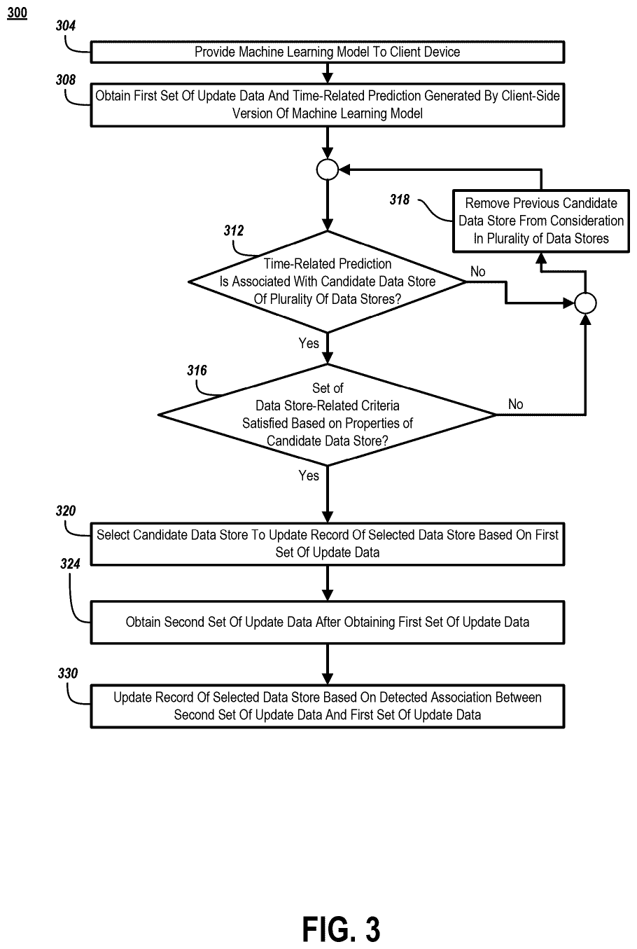

FIG. 3 is a flowchart of a process 300 for determining what data to store based on client-provided, time-related predictions, in accordance with one or more embodiments. Some embodiments may provide a machine learning model to a client device, as indicated by block 304. Providing a machine learning model may include making a set of parameters available to a client device that then downloads parameters of the machine learning model. For example, some embodiments may provide a set of weights, biases, or neural network hyperparameters of a neural network model to a client device. Some embodiments may provide various other types of parameters that depend on the type or architecture of the machine learning model being provided.

Some embodiments may use federated model and provide, to a client device, a machine learning model that uses locally accessible data of the client device when predicting a future time. Locally accessible data may include data that is stored directly on a client device. Alternatively, or additionally, locally accessible data may include data that is securely stored on a secure data source (e.g., data stored on a secured cloud database, data that is stored and encrypted on another device, etc.). For example, the machine learning model may accept, as inputs, a history of client device application activity, a current geographical location of the client device, a history of geographical locations of the client device, demographic information, or other private data stored on a client device. In some embodiments, the data used by the machine learning model may not necessarily be stored on a server. For example, some embodiments may provide an ensemble learning model to a client device, where the ensemble learning model is being used as a prediction model. The ensemble learning model may be configured to predict a future transaction time based on previous transaction data and a client device's single geographical location or a sequence of previous geographical locations. In some embodiments, a client device may provide, as an input, geographical data stored in a set of locally accessible data to an ensemble learning model stored locally on a device, where the set of locally accessible data is locally secured and not provided to other computer systems (e.g., a server). As described elsewhere in this disclosure, the client device may then provide an output of the prediction to a server, where the output indicates a future transaction time that may vary based on the client device location. By using a machine learning model that considers a transaction location or other types of location data as an input when predicting the time of a future event, some embodiments may provide more accurate predicted times.

Some embodiments may modify a client-side version of a machine learning model stored on a client device after providing the client device with a set of parameters defining the machine learning model. For example, after first providing a client device with a first set of neural network parameters defining the values used to define a client-side machine learning model, some embodiments may provide the client device with an additional set of parameters with which to replace the first set of neural network parameters. As described elsewhere in this disclosure, some embodiments may update a server-side version of machine learning model parameters. After such an update operation, some embodiments may send the updated server-side version of the machine learning model parameters to the client device.

In some embodiments, multiple machine learning models may be executing concurrently or in series to predict different time values for different durations. For example, some embodiments may provide multiple machine learning models to a client device by providing multiple sets of machine learning model parameters to the client device. Each set is used to configure a different version of a machine learning model or even different machine learning models having different model architectures. For example, some embodiments may provide a client device with both a first machine learning model and a second machine learning model by providing first model parameters corresponding with the first machine learning model and second model parameters corresponding with the second machine learning model.

In some embodiments, respective machine learning models may be configured to indicate likelihoods that a future target event occurs within respective time ranges, where the different machine learning models may be configured for different time ranges. For example, a first machine learning model may be configured to indicate a likelihood that a future target event occurs within a first time range between 0 hours and 6 hours and a second machine learning model may be configured to indicate a likelihood that a future target event occurs within a second time range greater than 6 hours and up to 24 hours. In some embodiments, the first time range may be associated with a first data store, and the second time range may be associated with a second data store. Some embodiments may then compare one or more of the likelihoods to a likelihood threshold to determine which data store to use for data storage. For example, some embodiments may select a first data store based on a determination that a probability value is greater than a likelihood threshold, where the probability value is a predicted likelihood that a target transaction or other target future event will occur within a first duration that is associated with the first data store. Alternatively, some embodiments may determine that the probability value associated with this first duration does not satisfy the likelihood threshold and that a second probability value is greater than the likelihood threshold. The second probability value represents a predicted likelihood that the target transaction or other target future event will occur within a second duration that begins after the first duration. In response, some embodiments may select, for data storage and data updating operations, a second data store associated with the second duration in lieu of the first data store. Furthermore, as described elsewhere in this disclosure, some embodiments may then update the selected data store with later update data that is associated with the first set of update data via a shared identifier or other shared information.

Some embodiments may obtain a first set of update data and a time-related prediction generated by a client-side version of the machine learning model, as indicated by block 308. A client device may be used to perform one or more operations that then trigger an update to a database record. In some embodiments, the client device may send the first set of update data that causes an update to a data store record or other information stored in a data store. Furthermore, the client device may generate a set of time-related predictions using a machine learning model. Some embodiments may then obtain the set of time-related predictions in association with the first set of update data. As described elsewhere in this disclosure, some embodiments may then use the set of time-related predictions to determine which data store to use when generating or updating a record based on the first set of update data.

Some embodiments may obtain time-related predictions that characterize a probability that a target future event will occur within a pre-set duration. For example, a set of predicted time-related values that is received from a client device may be a probability value indicating the likelihood that at least an established duration will pass before a next transaction occurs. In some embodiments, the established duration may represent an amount of time associated with a data store. For example, some embodiments may obtain a first time-related value equal to 0.65 and a second time-related value equal to 0.85, where the first time-related value indicates that a machine learning model being used by the client device predicts that the next transaction predicted to occur has a 65% likelihood of occurring within the first threshold duration D1 and an 85% likelihood of occurring within a second threshold duration D2, where D1 and D2 may represent different lengths of time. Some embodiments may then determine which data store to use for storing data provided by the client device based on these probability values, such as by selecting a first data store associated with the first duration based on a determination that 65% is greater than a first threshold. As described elsewhere in this disclosure, such a selection sets the first data store as the candidate data store for data storage of a record based on update data. Alternatively, if 65% is not greater than the first threshold, some embodiments may store the data in a second data store associated with the threshold duration D2 based on a determination that 85% is greater than a second threshold. Alternatively, if both the first and second likelihood values of 65% and 85% do not satisfy their respective thresholds associated with the respective data stores, some embodiments may select a third data store to store a record based on the first set of update data.

Some embodiments may implement federated learning operations by obtaining model parameters of the client-side version of the machine learning model. For example, a client-side device may receive a set of machine learning model parameters for a neural network designed to predict a future transaction time for a target transaction type based on data related to a first transaction. In some embodiments, the client-side device may detect the actual occurrence of a future transaction of the target transaction type and re-train the neural network to more accurately predict future transaction times of that target transaction type. Some embodiments may then transfer the machine learning model parameters or data derived from the machine learning model parameters (e.g., an average machine learning model parameter, machine learning model parameters that have been modified with a set of noise parameters to partially obfuscate their exact values, etc.).

Some embodiments may then update a server-side version of the machine learning model based on the model parameters. For example, after collecting a set of machine learning model parameters from a set of client-side devices, some embodiments may update a server-side version of the machine learning model parameters in a federated manner based on the collected machine learning model parameters. Updating the server-side version may include performing various types of operations that change one or more parameters (e.g., neural unit weight, bias, etc.) of the server-side version of the machine learning model. For example, some embodiments may replace a server-side parameter with a collected parameter, determine a set of average values based on the collected parameters, and add the average value to a stored set of parameters, etc. Furthermore, some embodiments may generate a new version of the machine learning model parameters based on a determination that a first set of predictions for a first set of client devices or user accounts are within an acceptable prediction accuracy range, and that a second set of predictions for a second set of client devices are outside the bounds of acceptable prediction accuracy range. Some embodiments may then update or generate a second version of the server-side machine learning model based on the machine learning model parameters collected from the second set of client devices (e.g., by determining average values of the machine learning model parameters and using the average values as the parameters of the second version).

Some embodiments may determine whether the time-related prediction is associated with a candidate data store of a plurality of data stores, as indicated by block 312. As described elsewhere, different operations may be performed based on the type of time-related prediction provided by a client device or otherwise determined by a prediction model. For example, some embodiments may obtain a set of time values indicating likely times at which a future update or other target event will occur or obtain a set of durations indicating likely durations within which a future update or other target event will occur. Some embodiments may then select a candidate data store to associate with the time-related prediction based on a determination that the indicated time is within a duration associated with the candidate data store or that the indicated duration maps to the duration associated with the candidate data store.

In some embodiments, the time-related value may be a probability that indicates a likelihood associated with a duration. Some embodiments may then select a corresponding duration associated with a first data store based on a determination that the corresponding duration maps to the first data store or is most similar in time to the first data store and that the probability satisfies a probability threshold. For example, embodiments may receive a first probability “0.30” and a second probability “0.98” as a part of a set of time-related predictions, where the first probability corresponds with a first duration that is mapped to a primary data store, and where the second probability corresponds with a second duration that is mapped to a secondary data store, and where a probability threshold is equal to “0.51.” Some embodiments may then select the secondary data store for use as a candidate data store in which to store a newly generated record based on an associated set of update data. For example, some embodiments may update a new transaction record of the candidate data store by generating the new transaction record in the candidate data store based on an obtained set of transaction information from a client device.

In some embodiments, a time-related prediction may be a probability value. The probability value may be multiplied by a pre-set duration to compute a score or may otherwise be used in combination with a pre-set duration to compute the score. This computed score may then be used by itself or in combination with other scores to determine whether to store data in a high throughput data store. For example, some embodiments may determine a product of a time-related prediction provided by a client device and a pre-set duration to determine an expected duration value. Some embodiments may determine the product as a part of a set of products used to determine expected duration from a probability distribution. For example, some embodiments may determine multiple products, where each product is a product of a respective pre-set duration and a probability associated with that respective pre-set duration. Some embodiments may then determine whether a storage duration threshold is satisfied based on the product, where the storage duration threshold may represent a maximum storage time available or permitted for a particular data store. For example, some embodiments may determine an expected duration equal to 36 hours based on a dot product of a first vector and a second vector, where the first vector represents a distribution of probabilities determined with a machine learning model, and the second vector represents a corresponding set of time values associated with this distribution of probabilities. Some embodiments may then compare the expected duration with a storage duration threshold equal to 48 hours and determine that the expected duration satisfies the storage duration threshold by being less than the storage duration threshold. Based on this result, some embodiments may then associate the time-related prediction with the data store associated with the storage duration threshold.

As described elsewhere in this disclosure, some embodiments may select the candidate data store from a plurality of data stores. For example, some embodiments may include or otherwise be able to access three or more data stores, each having their own average throughput values, which may be used as possible data store destinations. The plurality of data stores may include other data stores such as a second data store and a third data store, where each of the first, second, and third data stores may be characterized with difference throughput values indicating an amount of data that can be concurrently processed. For example, a first data store that is selected may have a throughput value equal to 100 GB per second (GB/s), a second data store of the plurality of data stores may have a throughput value equal to 10 GB/s, and a third data store of the plurality of data stores may have a throughput value equal to 1.0 GB/s. The possible data stores may also vary in other ways, such as varying with respect to latency.

In response to a determination that the time-related prediction is associated with the candidate data store, operations of the process 300 may proceed to operations described for block 316. Otherwise, operations of the process 300 may proceed to operations described for block 318.

Some embodiments may determine whether a set of data store-related criteria is satisfied based on properties of the candidate data store, as indicated by block 316. The other set of criteria may include criteria related to data store performance, data store memory availability, data store reliability, data store price for storage, or other types of information related to the first set of update data. For example, some embodiments may receive one or more memory-related values associated with data stores, such as a memory-related value associated with a first data store, where the memory-related value may indicate a total amount of available memory for data storage operations. Some embodiments may implement a requirement that a tentatively selected candidate data store must have a pre-requisite amount of available data for storage operations. For example, some embodiments may first determine, based on a shared identifier, that a first data store should be selected for data storage or data modification operations. Before finalizing the selection of the candidate data store, however, some embodiments may determine whether the candidate data store has at least 10% of its free memory available. Based on a determination that the candidate data store does have at least 10% of its free memory available, some embodiments may select the candidate data store as the selected data store for further operations. Based on a determination that the candidate data store does not have at least 10% of its free memory available, some embodiments may determine that the set of data store-related criteria is satisfied based on properties of the candidate data store.

In response to a determination that the set of data store-related criteria is satisfied based on properties of the candidate data store, operations of the process 300 may proceed to operations described for block 320. Otherwise, operations of the process 300 may return to operations described for block 318.

Some embodiments may remove the previous candidate data store from consideration for selection from the plurality of data stores, as indicated by block 318. Some embodiments may indicate that the previously selected candidate data store is no longer to be considered for record generation based on update data on a temporary basis, such as preventing the candidate data store from being considered for 24 hours, 48 hours, or some other number of hours. Alternatively, or additionally, some embodiments may indicate that the previously selected candidate data store is no longer to be considered for record generation until one or more conditions associated with the candidate data store are satisfied, such as a condition that a required throughput is satisfied, a required latency is satisfied, or a required amount of available memory is satisfied.

Some embodiments may select the candidate data store for use to update a record in the selected data store based on the first set of update data, as indicated by block 320. As described elsewhere in this disclosure, some embodiments may determine that a set of criteria is satisfied based on a time-related prediction or resource data related to a candidate data store. In response to determining that the set of criteria is satisfied, some embodiments may determine that a time-related prediction is associated with the selected data store and generate or otherwise update a record of the selected data store. Updating the record of the selected data store may include generating a new record in the selected data store based on the first set of update data. For example, some embodiments may generate a new record in the selected candidate data store that includes an index value indicated by the first set of update data, a transaction amount indicated by the first set of update data, and a second identifier indicated by the first set of update data. Alternatively, or additionally, some embodiments may modify a pre-existing record in the selected candidate data store based on the first set of update data.

Some embodiments may obtain a second set of update data after obtaining the first set of update data, as indicated by block 324. Some embodiments may obtain additional update data from the same client device that provided a first set of update data. For example, some embodiments may use the client device to execute a second transaction 4 hours after executing a first transaction, where data related to the first transaction was used to generate a record in a candidate data store using operations described in this disclosure. Alternatively, some embodiments may obtain the additional update data from another computer device, such as a second client device, a payment terminal, or another networked electronic device.

Some embodiments may update the record of the selected data store based on a detected association between the second set of update data and the first set of update data, as indicated by block 330. In some embodiments, the detected association between the first and second sets of update data may be a shared identifier. For example, some embodiments may receive a second set of update data and extract a user identifier from the second set of update data. Some embodiments may then retrieve a record from a selected data store based on the user identifier by querying the selected data store for the user identifier. Updating a record based on the second set of data may include performing an addition operation or another mathematical operation to modify a numerical value of the record based on a numeric value from the second set of data. For example, some embodiments may perform operations described in this disclosure to generate a record in a first data store, where the record includes the value 1500 for a first record field. Some embodiments may then receive a second set of data that includes the value “325,” retrieve the previously stored record from the first data store using operations described in this disclosure, and modify the record by adding “325” to “1500,” such that the updated record now stores “1825” in the first field.

Some embodiments may vary the granularity of a prediction based on a detected accuracy rate associated with the prediction. As described elsewhere in this disclosure, some embodiments may determine that a set of criteria associated with a selected data store is satisfied based on a time-related prediction, where satisfying the set of criteria includes determining that a threshold is satisfied. For example, some embodiments may determine that the set of criteria associated with the selected data store is satisfied based on a determination that a predicted time is within a first target duration associated with the selected data store. Some embodiments may receive feedback indicating a prediction accuracy of a prediction with respect to when additional update data is provided. For example, some embodiments may provide a client device with the machine learning model that predicts a future occurrence time for a future transaction of a target type based on the history of previous transactions. In some embodiments, the client device may keep track of whether a prediction ends up being accurate or inaccurate and, in response, determine a prediction accuracy based on a timestamp associated with a record of the actual future target event. Some embodiments may then update the threshold used in the set of criteria based on the prediction accuracy. For example, some embodiments may obtain information indicating that the prediction accuracy of a machine learning model is 80%. In response, some embodiments may update a likelihood threshold such that a greater likelihood is required in order for a system to determine that a predicted future event time is likely to be within a duration. For example, some embodiments may update a likelihood threshold from 75% to 90% based on a determination that a prediction accuracy is less than a target prediction accuracy threshold.

Some embodiments may detect an equipment or infrastructure failure and, in response, automatically re-direct stored data to a new data store. For example, some embodiments may obtain a set of update data in an associated time-related prediction from a client device. Some embodiments may determine, based on the associated time-related prediction, that the set of update data should be used to update a selected data store. Some embodiments may then receive an indication that the selected data store cannot be used for storage, such as by receiving an indication that an expected response from the selected data store has not been received. In response to a detected failure or other indication that a data store cannot be used, some embodiments may update another version of the record in a different data store or generate a new record in the different data store based on the set of update data.

When obtaining a second set of update data received after receiving a first set of update data having a same identifier as the second set of update data, some embodiments may obtain a second time-related prediction that is associated with the second set of update data. In some embodiments, a first time-related prediction associated with the first set of update data and a second time-related prediction associated with the second set of update data may be very different. After determining, based on the first time-related prediction, that a record should be generated in a first data store, some embodiments may select a second data store for record generation or updating based on the second time-related prediction. Some embodiments may then update the existing record stored in the first data store based on the second set of update data and transfer the updated record in the first data store to the second data store. Alternatively, some embodiments may generate a version of the updated record in the second data store directly without first updating the record in the first data store.

As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety (i.e., the entire portion), of a given item (e.g., data) unless the context clearly dictates otherwise. Furthermore, a “set” may refer to a singular form or a plural form, such that a “set of items” may refer to one item or a plurality of items.

In some embodiments, the operations described in this disclosure may be implemented in a set of processing devices (e.g., a digital processor, an analog processor, a digital circuit designed to process information, an analog circuit designed to process information, a state machine, and/or other mechanisms for electronically processing information). The processing devices may include one or more devices executing some or all of the operations of the methods in response to instructions stored electronically on a set of non-transitory, machine-readable media, such as an electronic storage medium. Furthermore, the use of the term “media” may include a single medium or combination of multiple media, such as a first medium and a second medium. A set of non-transitory, machine-readable media storing instructions may include instructions included on a single medium or instructions distributed across multiple media. The processing devices may include one or more devices configured through hardware, firmware, and/or software to be specifically designed for the execution of one or more of the operations of the methods. For example, it should be noted that one or more of the devices or equipment discussed in relation to FIGS. 1-2 could be used to perform one or more of the operations described in relation to FIG. 3.

It should be noted that the features and limitations described in any one embodiment may be applied to any other embodiment herein, and a flowchart or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

In some embodiments, the various computer systems and subsystems illustrated in FIG. 1 or FIG. 2 may include one or more computing devices that are programmed to perform the functions described herein. The computing devices may include one or more electronic storages (e.g., a set of databases accessible to one or more applications depicted in the system 100), one or more physical processors programmed with one or more computer program instructions, and/or other components. For example, the set of databases may include a relational database such as a PostgreSQL™ database or MySQL database. Alternatively, or additionally, the set of databases or other electronic storage used in this disclosure may include a non-relational database, such as a Cassandra™ database, MongoDB™ database, Redis database, Neo4j™ database, Amazon Neptune™ database, etc.

The computing devices may include communication lines or ports to enable the exchange of information with a set of networks (e.g., a network used by the system 100) or other computing platforms via wired or wireless techniques. The network may include the internet, a mobile phone network, a mobile voice or data network (e.g., a 5G or Long-Term Evolution (LTE) network), a cable network, a public switched telephone network, or other types of communications networks or combination of communications networks. A network described by devices or systems described in this disclosure may include one or more communications paths, such as Ethernet, a satellite path, a fiber-optic path, a cable path, a path that supports internet communications (e.g., IPTV), free-space connections (e.g., for broadcast or other wireless signals), Wi-Fi, Bluetooth, near field communication, or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Each of these devices described in this disclosure may also include electronic storages. The electronic storages may include non-transitory storage media that electronically stores information. The storage media of the electronic storages may include one or both of (i) system storage that is provided integrally (e.g., substantially non-removable) with servers or client computing devices, or (ii) removable storage that is removably connectable to the servers or client computing devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). An electronic storage may store software algorithms, information determined by the processors, information obtained from servers, information obtained from client computing devices, or other information that enables the functionality as described herein.

The processors may be programmed to provide information processing capabilities in the computing devices. As such, the processors may include one or more of a digital processor, an analog processor, a digital circuit designed to process information, an analog circuit designed to process information, a state machine, and/or other mechanisms for electronically processing information. In some embodiments, the processors may include a plurality of processing units. These processing units may be physically located within the same device, or the processors may represent the processing functionality of a plurality of devices operating in coordination. The processors may be programmed to execute computer program instructions to perform functions described herein of subsystems described in this disclosure or other subsystems. The processors may be programmed to execute computer program instructions by software; hardware; firmware; some combination of software, hardware, or firmware; and/or other mechanisms for configuring processing capabilities on the processors.

It should be appreciated that the description of the functionality provided by the different subsystems described herein is for illustrative purposes, and is not intended to be limiting, as any of subsystems described in this disclosure may provide more or less functionality than is described. For example, one or more of subsystems described in this disclosure may be eliminated, and some or all of its functionality may be provided by other ones of subsystems described in this disclosure. As another example, additional subsystems may be programmed to perform some or all of the functionality attributed herein to one of subsystems described in this disclosure.

With respect to the components of computing devices described in this disclosure, each of these devices may receive content and data via input/output (I/O) paths. Each of these devices may also include processors and/or control circuitry to send and receive commands, requests, and other suitable data using the I/O paths. The control circuitry may comprise any suitable processing, storage, and/or I/O circuitry. Further, some or all of the computing devices described in this disclosure may include a user input interface and/or user output interface (e.g., a display) for use in receiving and displaying data. In some embodiments, a display such as a touchscreen may also act as a user input interface. It should be noted that in some embodiments, one or more devices described in this disclosure may have neither user input interface nor displays and may instead receive and display content using another device (e.g., a dedicated display device such as a computer screen and/or a dedicated input device such as a remote control, mouse, voice input, etc.). Additionally, one or more of the devices described in this disclosure may run an application (or another suitable program) that performs one or more operations described in this disclosure.

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment may be combined with one or more features of any other embodiment.

As used throughout this application, the word “may” is used in a permissive sense (i.e., meaning having the potential to), rather than the mandatory sense (i.e., meaning must). The words “include,” “including,” “includes,” and the like mean including, but not limited to. As used throughout this application, the singular forms “a,” “an,” and “the” include plural referents unless the context clearly indicates otherwise. Thus, for example, reference to “an element” or “the element” includes a combination of two or more elements, notwithstanding the use of other terms and phrases for one or more elements, such as “one or more.” The term “or” is non-exclusive (i.e., encompassing both “and” and “or”), unless the context clearly indicates otherwise. Terms describing conditional relationships (e.g., “in response to X, Y,” “upon X, Y,” “if X, Y,” “when X, Y,” and the like) encompass causal relationships in which the antecedent is a necessary causal condition, the antecedent is a sufficient causal condition, or the antecedent is a contributory causal condition of the consequent (e.g., “state X occurs upon condition Y obtaining” is generic to “X occurs solely upon Y” and “X occurs upon Y and Z”). Such conditional relationships are not limited to consequences that instantly follow the antecedent obtaining, as some consequences may be delayed, and in conditional statements, antecedents are connected to their consequents (e.g., the antecedent is relevant to the likelihood of the consequent occurring). Statements in which a plurality of attributes or functions are mapped to a plurality of objects (e.g., a set of processors performing steps/operations A, B, C, and D) encompass all such attributes or functions being mapped to all such objects and subsets of the attributes or functions being mapped to subsets of the attributes or functions (e.g., both/all processors each performing steps/operations A-D, and a case in which processor 1 performs step/operation A, processor 2 performs step/operation B and part of step/operation C, and processor 3 performs part of step/operation C and step/operation D), unless otherwise indicated. Further, unless otherwise indicated, statements that one value or action is “based on” another condition or value encompass both instances in which the condition or value is the sole factor and instances in which the condition or value is one factor among a plurality of factors.

Unless the context clearly indicates otherwise, statements that “each” instance of some collection has some property should not be read to exclude cases where some otherwise identical or similar members of a larger collection do not have the property (i.e., each does not necessarily mean each and every). Limitations as to the sequence of recited steps should not be read into the claims unless explicitly specified (e.g., with explicit language like “after performing X, performing Y”) in contrast to statements that might be improperly argued to imply sequence limitations (e.g., “performing X on items, performing Y on the X'ed items”) used for purposes of making claims more readable rather than specifying a sequence. Statements referring to “at least Z of A, B, and C,” and the like (e.g., “at least Z of A, B, or C”), refer to at least Z of the listed categories (A, B, and C) and do not require at least Z units in each category. Unless the context clearly indicates otherwise, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Furthermore, unless indicated otherwise, updating an item may include generating the item or modifying an existing item. Thus, updating a record may include generating a record or modifying the value of an already-generated value in a record.

Unless the context clearly indicates otherwise, ordinal numbers used to denote an item do not define the item's position. For example, an item that may be a first item of a set of items even if the item is not the first item to have been added to the set of items or is otherwise indicated to be listed as the first item of an ordering of the set of items. Thus, for example, if a set of items is sorted in a sequence from “item 1,” “item 2,” and “item 3,” a first item of a set of items may be “item 2” unless otherwise stated.

The present techniques will be better understood with reference to the following enumerated embodiments:

1. A method comprising: obtaining, from a client device, a first set of update data and a time-related prediction generated by a client-side version of a machine learning model; determining that the time-related prediction is associated with a first data store of a plurality of data stores comprising the first data store and a second data store; updating a record in the first data store based on the first set of update data in response to a determination that the time-related prediction is associated with the first data store; and updating the record in the first data store based on a second set of update data obtained after obtaining the first set of update data.
2. The method of embodiment 1, wherein the first data store is characterized by a first throughput value, and wherein the second data store is characterized by a second throughput value.
3. The method of any of embodiments 1 to 2, wherein the second set of update data shares an identifier with the first set of update data.
4. A method comprising one or more processors and one or more non-transitory, machine-readable media storing program instructions that, when executed by the one or more processors, performs operations comprising: providing, to a client device, a machine learning model that outputs time-related predictions indicating a most probable time for a future event based on update data; obtaining, from the client device, initial update data and a time-related prediction that is generated by the client device, wherein the time-related prediction is generated by providing the initial update data to the machine learning model as an input; determining that the time-related prediction satisfies a set of criteria associated with a first data store of a plurality of data stores comprising the first data store and a second data store, wherein the first data store is characterized by a first throughput value, and wherein the second data store is characterized by a second throughput value; determining that the time-related prediction is associated with the first data store based on a determination that the time-related prediction satisfies the set of criteria; updating a record in the first data store based on the initial update data in response to a determination that the time-related prediction is associated with the first data store; receiving, from the client device, additional update data after obtaining the initial update data, wherein the additional update data shares an identifier with the initial update data; retrieving the record based on an association between the additional update data and the initial update data; and updating the record in the first data store based on the additional update data.
5. A method comprising: providing, to a client device, a machine learning model; obtaining, from the client device, a first set of update data and a time-related prediction generated by providing a client-side version of the machine learning model with at least one value of the first set of update data; determining a result indicating that the time-related prediction is associated with a first data store of a plurality of data stores comprising the first data store and a second data store, wherein the first data store is characterized by a first throughput value, and wherein the second data store is characterized by a second throughput value; updating a record of the first data store based on the first set of update data in response to the result indicating that the time-related prediction is associated with the first data store; and updating the record of the first data store based on a second set of update data by retrieving the record of the first data store based on an association between the second set of update data and the first set of update data.
6. The method of any of embodiments 1 to 5, further comprising: obtaining, from the client device, a third set of update data, wherein the third set of update data comprises a timestamp indicating a transaction time; determining a result indicating that the transaction time is not within a first time range associated with the first data store; updating training data based on the third set of update data in response to the result indicating that the transaction time is not within the first time range; and updating a server-side version of the machine learning model based on the training data after the training data is updated with the third set of update data.
7. The method of any of embodiments 1 to 6, wherein updating the record in the first data store comprises: determining an available memory of the first data store; and determining a result indicating that the available memory satisfies a set of memory-related criteria, wherein updating the record comprises updating the record in response to the result indicating that the available memory satisfies the set of memory-related criteria.
8. The method of any of embodiments 1 to 7, wherein the time-related prediction is a first time value, and wherein the record is a first record, further comprising: obtaining, from the client device, a third set of update data in association with a second time value; determining a second result indicating that the second time value is associated with the second data store; and updating a second record of the second data store based on the third set of update data in response to the second result indicating that the second time value is associated with the second data store.
9. The method of embodiment 8, further comprising storing data from the first record in the second data store based on the second result.
10. The method of any of embodiments 1 to 9, wherein the plurality of data stores comprises a third data store, and wherein the third data store is characterized by a third throughput value that is greater than the first throughput value and less than the second throughput value.
11. The method of embodiment 10, wherein the record is a first record, and wherein the time-related prediction is a first time value, further comprising: obtaining, from the client device, a second record in association with a second time value, wherein the second time value is different from the first time value; determining, based on the second time value, a result indicating that the second time value is associated with the third data store; and storing the second record in the third data store based on the result indicating that the second time value is associated with the third data store.
12. The method of any of embodiments 1 to 11, further comprising: obtaining model parameters of the client-side version of the machine learning model; and updating a server-side version of the machine learning model based on the model parameters.
13. The method of any of embodiments 1 to 12, wherein: the first set of update data comprises location data; and the machine learning model is configured to provide the time-related prediction based on the location data.
14. The method of any of embodiments 1 to 13, further comprising sending model parameter data to the client device, wherein the client device reconfigures one or more parameters of the client-side version of the machine learning model based on the model parameter data.
15. The method of any of embodiments 1 to 14, wherein the time-related prediction comprises a probability value indicating a likelihood that a target future event will occur within a pre-set duration.
16. The method of embodiment 15, wherein determining that the time-related prediction is associated with the first data store comprises: determining a product based on the time-related prediction and the pre-set duration; determining that a storage duration threshold is satisfied based on the product; and determining that the time-related prediction is associated with the first data store based on a determination that the product satisfies the storage duration threshold.
17. The method of any of embodiments 1 to 16, wherein the machine learning model is a first machine learning model, and wherein the time-related prediction is a first time-related prediction, the operations further comprising: providing the client device with the first machine learning model and a second machine learning model, wherein: the first time-related prediction indicates a likelihood that a future target event occurs within a first time range associated with the first data store; a client-side version of the second machine learning model provides a second time-related prediction; the second time-related prediction indicates a likelihood that the future target event occurs within a second time range associated with the second data store; and obtaining, from the client device, the second time-related prediction, wherein determining that the time-related prediction is associated with the first data store comprises comparing the first time-related prediction with the second time-related prediction.
18. The method of any of embodiments 1 to 17, wherein: determining that the time-related prediction is associated with the first data store comprises: determining that a set of criteria associated with the first data store is satisfied by the time-related prediction; and determining that the time-related prediction is associated with the first data store based on the determination that the set of criteria associated with the first data store is satisfied by the time-related prediction; the operations further comprising: determining a prediction accuracy based on a timestamp associated with the second set of update data and the time-related prediction; and modifying a threshold of the set of criteria based on the prediction accuracy.
19. The method of any of embodiments 1 to 18, further comprising: obtaining, from the client device, a third set of update data and a second time-related prediction generated by the client-side version of the machine learning model; determining that the third set of update data is associated with the first data store based on the machine learning model; receiving an indication that the first data store cannot be used for storage; and updating a second record stored in a third data store based on the third set of update data.
20. The method of any of embodiments 1 to 19, further comprising determining a memory-related value associated with the first data store, wherein determining that the time-related prediction is associated with the first data store comprises determining that the time-related prediction is associated with the first data store based on the memory-related value.
21. The method of any of embodiments 1 to 20, wherein: the client device stores a set of locally accessible data, wherein the first set of update data does not comprise the set of locally accessible data; and the machine learning model is configured to provide the time-related prediction based on the set of locally accessible data.
22. The one or more non-transitory, machine-readable media of embodiment 21, wherein the set of locally accessible data comprises a history of locations.
23. One or more tangible, non-transitory, machine-readable media storing instructions that, when executed by a set of processors, cause the set of processors to effectuate operations comprising those of any of embodiments 1 to 22.
24. A system comprising: a set of processors and a set of media storing computer program instructions that, when executed by the set of processors, cause the set of processors to effectuate operations comprising those of any of embodiments 1 to 22.

What is claimed is:

1. A system for selectively determining which data store to use for storing data based on client-provided time-related predictions, the system comprising one or more processors and one or more non-transitory, machine-readable media storing program instructions that, when executed by the one or more processors, perform operations comprising:
providing, to a client device, a machine learning model that outputs time-related predictions indicating a most probable time for a future event based on update data;
obtaining, from the client device, initial update data and a time-related prediction that is generated by the client device, wherein the time-related prediction is generated by providing the initial update data to the machine learning model as an input;
determining that the time-related prediction satisfies a set of criteria associated with a first data store of a plurality of data stores comprising the first data store and a second data store, wherein the first data store is characterized by a first throughput value, and wherein the second data store is characterized by a second throughput value;
determining that the time-related prediction is associated with the first data store based on a determination that the time-related prediction satisfies the set of criteria;
updating a record in the first data store based on the initial update data in response to a determination that the time-related prediction is associated with the first data store;
receiving, from the client device, additional update data after obtaining the initial update data, wherein the additional update data shares an identifier with the initial update data;
retrieving the record based on an association between the additional update data and the initial update data; and
updating the record in the first data store based on the additional update data.

2. A method comprising:
providing, to a client device, a machine learning model;
obtaining, from the client device, a first set of update data and a time-related prediction generated by providing a client-side version of the machine learning model with at least one value of the first set of update data;
determining a result indicating that the time-related prediction is associated with a first data store of a plurality of data stores comprising the first data store and a second data store, wherein the first data store is characterized by a first throughput value, and wherein the second data store is characterized by a second throughput value;
updating a record of the first data store based on the first set of update data in response to the result indicating that the time-related prediction is associated with the first data store; and
updating the record of the first data store based on a second set of update data by retrieving the record of the first data store based on an association between the second set of update data and the first set of update data.

3. The method of claim 2, further comprising:
obtaining, from the client device, a third set of update data, wherein the third set of update data comprises a timestamp indicating a transaction time;
determining a result indicating that the transaction time is not within a first time range associated with the first data store;
updating training data based on the third set of update data in response to the result indicating that the transaction time is not within the first time range; and
updating a server-side version of the machine learning model based on the training data after the training data is updated with the third set of update data.

4. The method of claim 2, wherein updating the record in the first data store comprises:
determining an available memory of the first data store; and
determining a result indicating that the available memory satisfies a set of memory-related criteria, wherein updating the record comprises updating the record in response to the result indicating that the available memory satisfies the set of memory-related criteria.

5. The method of claim 2, wherein the time-related prediction is a first time value, and wherein the record is a first record, further comprising:
obtaining, from the client device, a third set of update data in association with a second time value;
determining a second result indicating that the second time value is associated with the second data store; and
updating a second record of the second data store based on the third set of update data in response to the second result indicating that the second time value is associated with the second data store.

6. The method of claim 5, further comprising storing data from the first record in the second data store based on the second result.

7. The method of claim 2, wherein the plurality of data stores comprises a third data store, and wherein the third data store is characterized by a third throughput value that is greater than the first throughput value and less than the second throughput value.

8. The method of claim 7, wherein the record is a first record, and wherein the time-related prediction is a first time value, further comprising:
obtaining, from the client device, a second record in association with a second time value, wherein the second time value is different from the first time value;
determining, based on the second time value, a result indicating that the second time value is associated with the third data store; and
storing the second record in the third data store based on the result indicating that the second time value is associated with the third data store.

9. The method of claim 2, further comprising:
obtaining model parameters of the client-side version of the machine learning model; and
updating a server-side version of the machine learning model based on the model parameters.

10. The method of claim 2, wherein:
the first set of update data comprises location data; and
the machine learning model is configured to provide the time-related prediction based on the location data.

11. One or more non-transitory, machine-readable media storing program instructions that, when executed by one or more processors, cause the one or more processors to perform operations comprising:
obtaining, from a client device, a first set of update data and a time-related prediction generated by a client-side version of a machine learning model;
determining that the time-related prediction is associated with a first data store of a plurality of data stores comprising the first data store and a second data store, wherein the first data store is characterized by a first throughput value, and wherein the second data store is characterized by a second throughput value;
updating a record in the first data store based on the first set of update data in response to a determination that the time-related prediction is associated with the first data store; and
updating the record in the first data store based on a second set of update data obtained after obtaining the first set of update data, wherein the second set of update data shares an identifier with the first set of update data.

12. The one or more non-transitory, machine-readable media of claim 11, further comprising sending model parameter data to the client device, wherein the client device reconfigures one or more parameters of the client-side version of the machine learning model based on the model parameter data.

13. The one or more non-transitory, machine-readable media of claim 11, wherein the time-related prediction comprises a probability value indicating a likelihood that a target future event will occur within a pre-set duration.

14. The one or more non-transitory, machine-readable media of claim 13, wherein determining that the time-related prediction is associated with the first data store comprises:
determining a product based on the time-related prediction and the pre-set duration;
determining that a storage duration threshold is satisfied based on the product; and
determining that the time-related prediction is associated with the first data store based on a determination that the product satisfies the storage duration threshold.

15. The one or more non-transitory, machine-readable media of claim 11, wherein the machine learning model is a first machine learning model, and wherein the time-related prediction is a first time-related prediction, the operations further comprising:
providing the client device with the first machine learning model and a second machine learning model, wherein:
the first time-related prediction indicates a likelihood that a future target event occurs within a first time range associated with the first data store;
a client-side version of the second machine learning model provides a second time-related prediction; and
the second time-related prediction indicates a likelihood that the future target event occurs within a second time range associated with the second data store; and
obtaining, from the client device, the second time-related prediction, wherein determining that the time-related prediction is associated with the first data store comprises comparing the first time-related prediction with the second time-related prediction.

16. The one or more non-transitory, machine-readable media of claim 11, wherein:
determining that the time-related prediction is associated with the first data store comprises:
determining that a set of criteria associated with the first data store is satisfied by the time-related prediction; and
determining that the time-related prediction is associated with the first data store based on the determination that the set of criteria associated with the first data store is satisfied by the time-related prediction;
the operations further comprising:
determining a prediction accuracy based on a timestamp associated with the second set of update data and the time-related prediction; and
modifying a threshold of the set of criteria based on the prediction accuracy.

17. The one or more non-transitory, machine-readable media of claim 11, further comprising:
obtaining, from the client device, a third set of update data and a second time-related prediction generated by the client-side version of the machine learning model;
determining that the third set of update data is associated with the first data store based on the machine learning model;
receiving an indication that the first data store cannot be used for storage; and
updating a second record stored in a third data store based on the third set of update data.

18. The one or more non-transitory, machine-readable media of claim 11, further comprising determining a memory-related value associated with the first data store, wherein determining that the time-related prediction is associated with the first data store comprises determining that the time-related prediction is associated with the first data store based on the memory-related value.

19. The one or more non-transitory, machine-readable media of claim 11, wherein:
the client device stores a set of locally accessible data, wherein the first set of update data does not comprise the set of locally accessible data; and
the machine learning model is configured to provide the time-related prediction based on the set of locally accessible data.

20. The one or more non-transitory, machine-readable media of claim 19, wherein the set of locally accessible data comprises a history of locations.
